(19) United States
(12) Patent Application Publication
(10) Pub. No.: US 2013/0023807 A1
(43) Pub. Date: Jan. 24, 2013

(54) MASSAGER

(71) Applicant: Daniel J. Hennessey, Como, CO (US)

(72) Inventor: Daniel J. Hennessey, Como, CO (US)

(21) Appl. No.: 13/188,308

(22) Filed: Jul. 21, 2011

(51) Int. Cl. A61H 15/00; A61H 7/00

(52) U.S. Cl. 601/119; 601/137

(57) ABSTRACT

Massagers are disclosed herein. An embodiment of a massager comprises a first portion and a second portion. The first portion comprises a first end and a second end wherein at least a section of the first portion between the first end and the second end is curved. A first coupling device is located on the first end and is configured to receive a massage element. A second coupling device is located proximate the second end. The second coupling device is configured to attach to a third coupling device on the second portion of the massager to join the first and second portions. The second portion comprises a substantially straight member extending between a first end and a second end, wherein the third coupling device is located on the second end.

This application claims priority of U.S. provisional application 61/366,258 of Daniel Hennessey for MASSAGER filed on Jul. 21, 2010, which is incorporated for all that is disclosed.

### BACKGROUND

Body massagers, sometimes simply referred to as massagers, serve to enable a user to massage a portion of his body. Some massagers have an arm with a ball or the like affixed thereto. The user rubs the ball into his muscles in order to massage his muscles. These massagers tend to be bulky as they are large enough for a user to massage his back while holding the massager in front of him.

### BRIEF DESCRIPTION OF THE DRAWINGS

FIG. 1 is a top plan view of an embodiment of a massager.

FIG. 2 is a top plan view of an embodiment of the curved portion of the massager of FIG. 1.

FIG. 3 is a top plan view of an embodiment of the straight portion of the massager of FIG. 1.

FIG. 4 is a perspective view of the massager of FIG. 1 showing the separated portions and some massage elements.

FIG. 5 is a side elevation view of an embodiment of a ball massage element of FIG. 4.

FIG. 6 is a perspective view of the wheel of FIG. 5.

FIG. 7 is a perspective view of the axle of FIG. 5.

FIG. 8 is a perspective view of an embodiment of a wheel-type massage element having a plurality of protrusions.

FIG. 9 is a perspective view of an embodiment of a massage element in the form of a scratcher.

FIG. 10 is a side cut away view of an embodiment of the coupling device of FIG. 1.

FIG. 11 is a side view of an embodiment of a coupling mechanism between the curved portion and the straight portion of the massager.

FIG. 12 is an end view of another embodiment of a coupling mechanism.

FIG. 13 is a perspective view of another embodiment of a coupling mechanism.

FIG. 14 is an enlarged view of the second end of the straight portion of the massager of FIG. 13.

FIG. 15 is another enlarged view of the second end of the straight portion of the massager of FIG. 13.

FIG. 16 is a view of the first end of the massager of FIG. 13.

FIG. 17 is a view of the first end of the massager of FIG. 13 showing the opposite side of FIG. 17.

### DETAILED DESCRIPTION

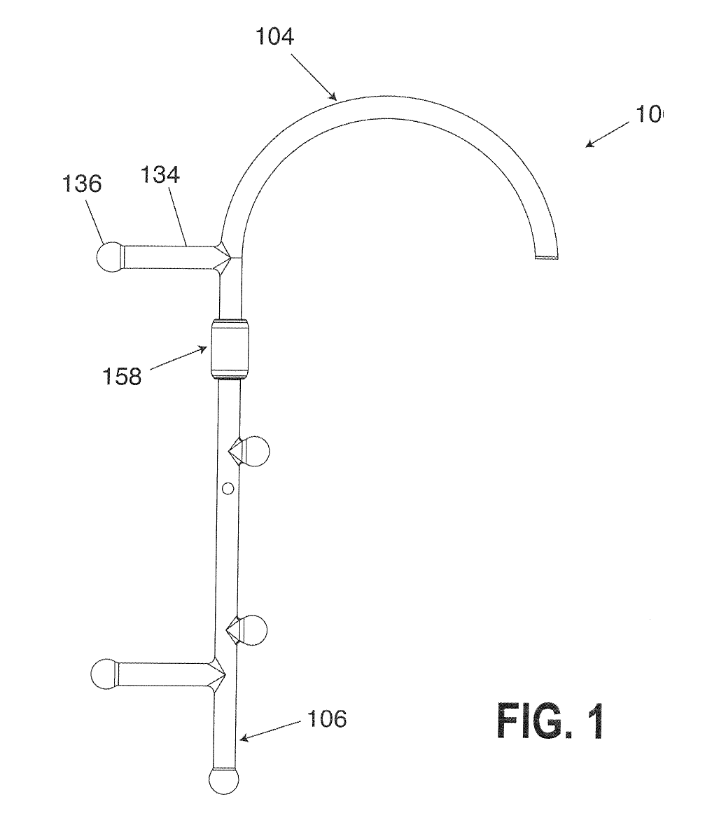

An embodiment of a top plan view of a massager 100 is shown in FIG. 1. The massager 100 includes two portions which are referred to herein as a first or curved portion 104 and a second or straight portion 106. The curved portion 104 is removable from the straight portion 106 so as to enable the massager 100 to be taken apart and reassembled as described in greater detail below. It is noted that portions other than a straight portion and a curved portion may be used herein.

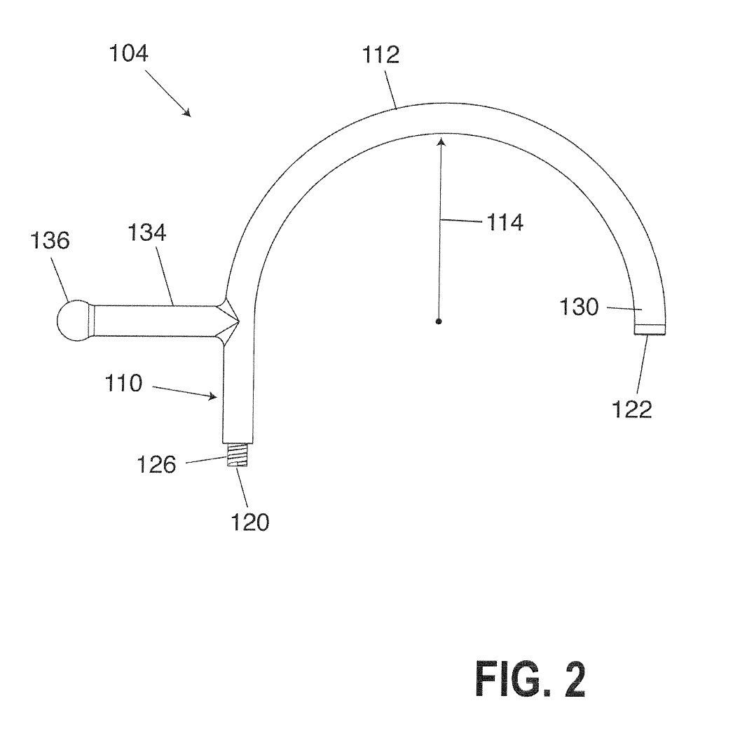

An embodiment of the curved portion 104 is shown in FIG. 2. The curved portion 104 may not be completely curved. Rather, as shown in FIGS. 1 and 2, the curved portion 104 may have a straight section 110 and a curved section 112. In the embodiment of FIGS. 1 and 2, the curved portion 104 extends between a first end 120 and a second end 122 and includes the straight section 110 and the curved section 112.

The term curved portion means that the portion contains a substantial curve between the first end 120 and the second end 122. In the embodiment of FIGS. 1 and 2, the curved section 112 is a semicircle defined by a radius 114 and constitutes a substantial curve. However, the curved section 112 does not have to be that substantial and does not have to be circular. The curved section 112 needs to be large enough to enable a user of the massager 100 to contact his back with the massager as described in greater detail below. In some embodiments, a curved portion may be a section of the massager that has a radius of forty-five to ninety degrees.

The first end 120 of the curved portion 104 has a coupling section located thereon or proximate thereto that enables the curved portion 104 to be attached to the straight portion 106. In the embodiment of FIG. 2, the coupling section is a threaded portion 126 that enables the curved portion 104 to be screwed into a corresponding tapped portion in the straight portion 106. The reference numeral 126 may be applied to both the coupling section and the threads. Other coupling devices and methods are described in greater detail below.

It is noted that the second end 122 of the curved portion 104 also has a coupling section 130 located thereabout. The coupling section 130 serves to secure a massage element to the second end 122 as described in greater detail below. In the embodiment of FIG. 2, the coupling section 130 is section of the second end 122 that is tapped. The tapped section is configured to receive a threaded rod, such as a bolt, that may be affixed to a massage element. Other methods and devices for securing massage elements to the massager 100 are described in greater detail below.

The curved portion 104 of FIG. 2 has a first handle 134 extending therefrom. The first handle 134 may be used to hold the massager 100 or it may be used to massage the user. The first handle 134 extends in a direction that is opposite the concave curve of the curved section 112. In some embodiments, the first handle 134 is detachable from the curved portion 104. The first handle 134 has a ball 136 attached thereto. The ball 136 may serve as a massage element. The ball 136 may also serve to help a user hold the first handle 134 by preventing the first handle 134 from slipping from a user's hand. In some embodiments, the ball 136 is detachable and may be substituted with other massage elements as described below.

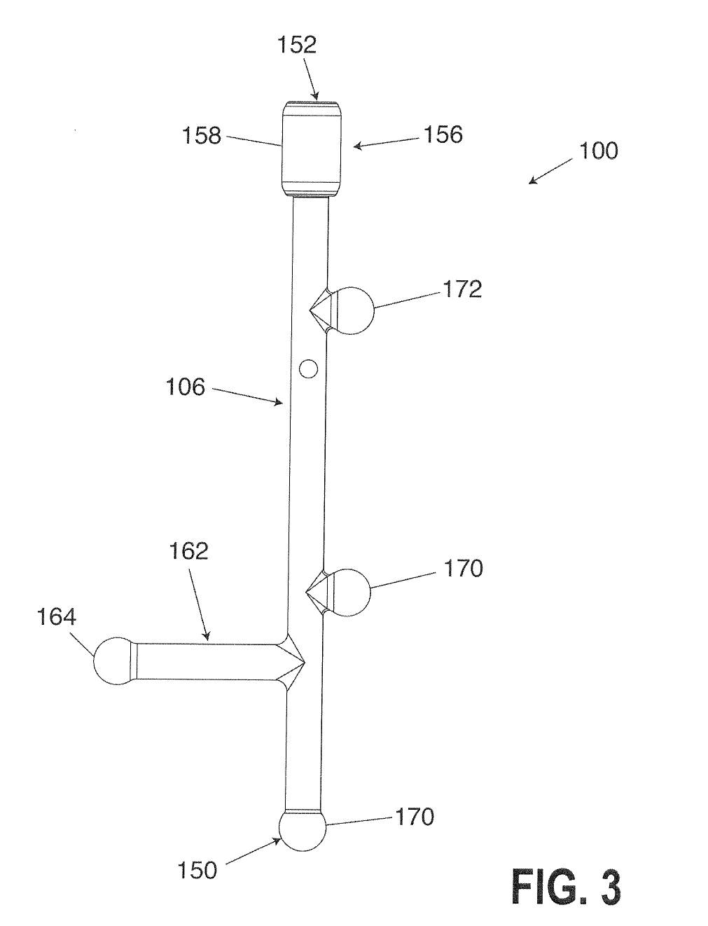

Having described the curved portion 104, the straight portion 106 will now be described. Referring to FIG. 3, which is a plan view of the straight portion 106, the straight portion 106 extends between a first end 150 and a second end 152. The second end 152 has a coupling section 156 that couples to the coupling section 126, FIG. 2, of the curved portion 104. In the embodiment of FIG. 3, the coupling section 156 includes a tapped hole that receives the threads 126 on the first end 120 of the curved portion 104. The second end 152 has a reinforcing member 158 that extends over the coupling sections 126, 156 between the curved portion 104 and the straight portion 106. The reinforcing member 158 strengthens the junction between the curved portion 104 and the straight portion 106. In the embodiment of FIGS. 1 and 3, the reinforcing member 158 extends over the threads 126 in the curved portion 104 and the straight portion 106, which increases the strength in the junction. The reinforcing member 158 may be integrally formed with the straight section 106. For example, the straight section 106 may be formed from a mold that includes the reinforcing member 158.

The coupling section 126 and the coupling section 156 may be configured to position the curved portion 104 and the straight portion 106 in a preselected configuration relative to each other when they are joined. For example, if threads are used in the coupling sections 126, 156, the threads may cause the portions 104, 106 to be aligned as shown in FIG. 1 when they are tightened. Pins or other devices may be used that achieve the same alignment.

The first end 150 of the straight portion 106 has a massage element 160 attached thereto. The massage element shown in FIG. 3 is a ball, however, many different types of massage elements, as described herein, may be attached to the first end 150. In some embodiments, the massage elements are detachably connected to the first end 150 in a manner similar or identical to the manner in which massage elements are attached to the second end 122, FIG. 2, of the curved portion 104. For example, the massage elements may be screwed into the first end 150.

The straight portion 106 has a second handle 162 extending therefrom. The second handle 162 may be substantially similar to the first handle 134, FIG. 2. For example, the second handle 162 may be detachable from the straight portion 106. Like the first handle 134, the second handle 162 has a massage element 164 attachable thereto. The massage element 164 may be a ball as shown in FIG. 3 or another type of massage element. The ball or other massage element 164 helps the user secure the second handle 162 when using the massager 100. The massage element 164 also enables a user to massage muscles with the massage element 164. As briefly described above, in some embodiments, the second handle 162 is detachable from the straight portion 106. For example, the second handle 162 may have a threaded portion that screws into a tapped hole in the straight portion 106. In some embodiments, the second handle 162 extends substantially parallel to the first handle 134 when the straight portion 106 is attached to the curved portion 104 as shown in FIG. 1.

The straight portion 106 may have a plurality of additional massage elements attached thereto. In the embodiment of FIG. 3, the straight portion 106 has two additional massage elements, which are referred to as the first massage element 170 and the second massage element 172. The first and second massage elements 170, 172 are shown in FIG. 3 as being balls. However, it is noted that they can be other types of massage elements as described below. Like the other massage elements, the first and second massage elements 170, 172 may be removable. For example, they may screw into the straight portion 106.

Referring to FIG. 1, the massager 100 may be made of a plurality of different materials. In many embodiments, the material is substantially rigid or semirigid and may be forms of plastics or glass filled nylon. The massager 100 and the massage elements described herein may be formed by a molding process.

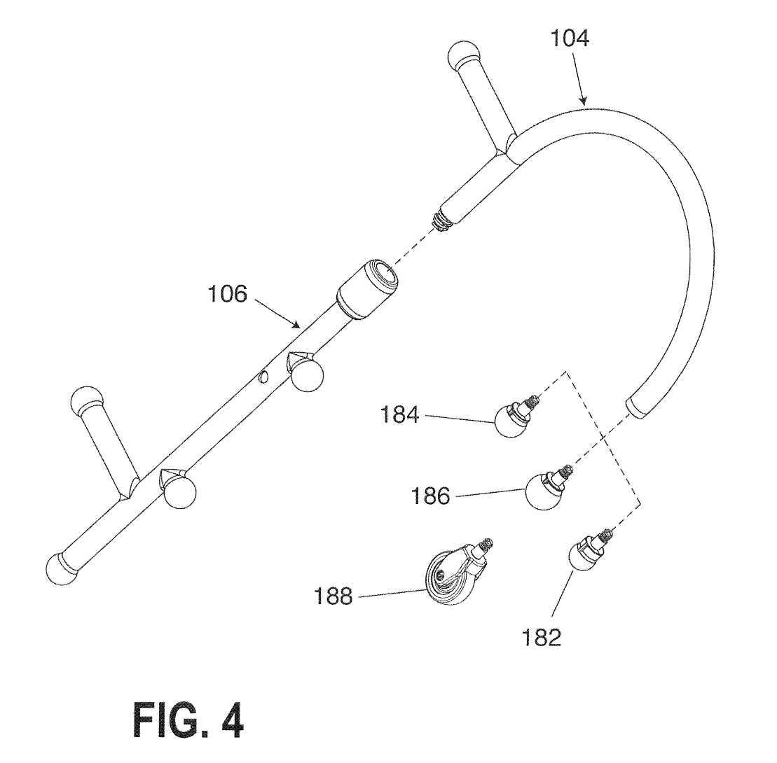

Having described some embodiments of the massager 100, embodiments of different massage elements will now be described. Reference is made to FIG. 4, which is a perspective view of the massager 100 showing the separate curved portion 104 and straight portion 106 in addition to some of the massage elements that may be attached to the portions 104, 106. FIG. 4 shows four different massage elements 180 that may be attached to the second end 122 of the curved portion 104. The massage elements 180 include a small ball 182, a medium ball 184, a large ball 186, and a roller 188. It is noted that the massage elements 180 may be used or substituted for any of the massage elements associated with the massager 100 and are not limited to being attached to the second end 122 of the curved portion 104.

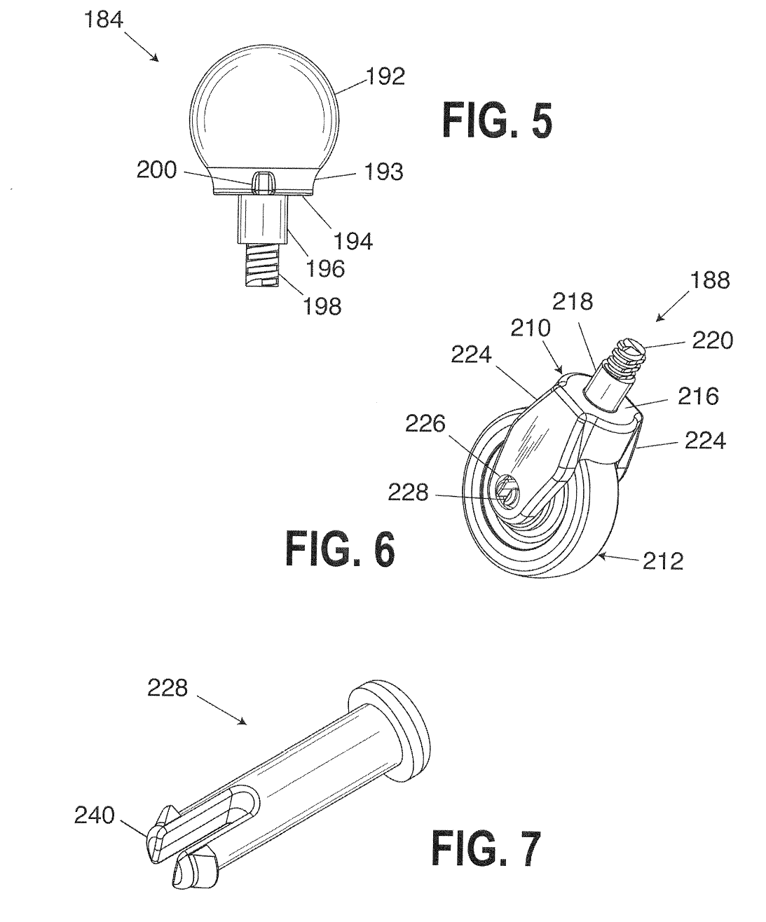

A more detailed view of the medium ball 184 is shown in FIG. 5. The medium ball 184 is representative of all the balls 182, 184, 186 of FIG. 4, except for differences in dimensions. The ball 184 includes a head 192 that may be substantially spherical or at least partially spherical. The head 192 may have a diameter of approximately one inch. In some embodiments, the small ball 182 has a head with a diameter of approximately 0.875 inches and the large ball 186 has a head with a diameter of approximately 1.125 inches.

The head 192 may abut a tapered portion 193 that is a transition between the head 192 and a surface 194. The surface 194 is configured to contact either the straight portion 106, FIG. 1, or the curved portion 104, FIG. 1, adjacent the location where the ball 184 attaches thereto. A shaft 196 may extend from the surface 194. The shaft 196 serves to further secure the ball 184 to the straight portion 106 or the curved portion 104. Threads 198 may extend from the shaft 196 or the threads 198 may be cut into the shaft 196. It is noted that in some embodiments, the threads 198 extend to the surface 194 and the shaft 196 does not exist.

The ball 184 is screwed into a location on the straight portion 106 or the curved portion 104. For example, as shown in FIG. 4, the ball 184 is able to be screwed into the second end 122 of the curved portion 104. The corresponding threads in the second end 122 may be located a distance beyond the second end 122 that corresponds to the length of the shaft 196. By locating the threads within the first end 122, the ball 184 is less likely to move or rock during use and is able to withstand greater forces than if the threads 198 only extended the length of the shaft 196. In some embodiments, the tapered portion 193 has a tab 200 extending therefrom that facilitates a user screwing the ball 184 into a portion 104, 106.

A more detailed view of the roller 188 is shown in FIG. 6, which is a perspective view of the roller 188. The roller 188 includes a frame 210 that supports a wheel 212. As described below, the wheel 212 may be replaceable in the frame 210 with other massage elements. The frame 210 has a surface 216 that is similar or identical to the surface 194 on the ball 184 of FIG. 5. Likewise, the frame 210 has a shaft 218 and threads 220 that are similar or identical to the shaft 196 and threads 198 on the ball 184 of FIG. 5. Accordingly, the roller 188 is able to screw into a portion 104, 106 of the massager 100 in a manner similar or identical to the balls 180.

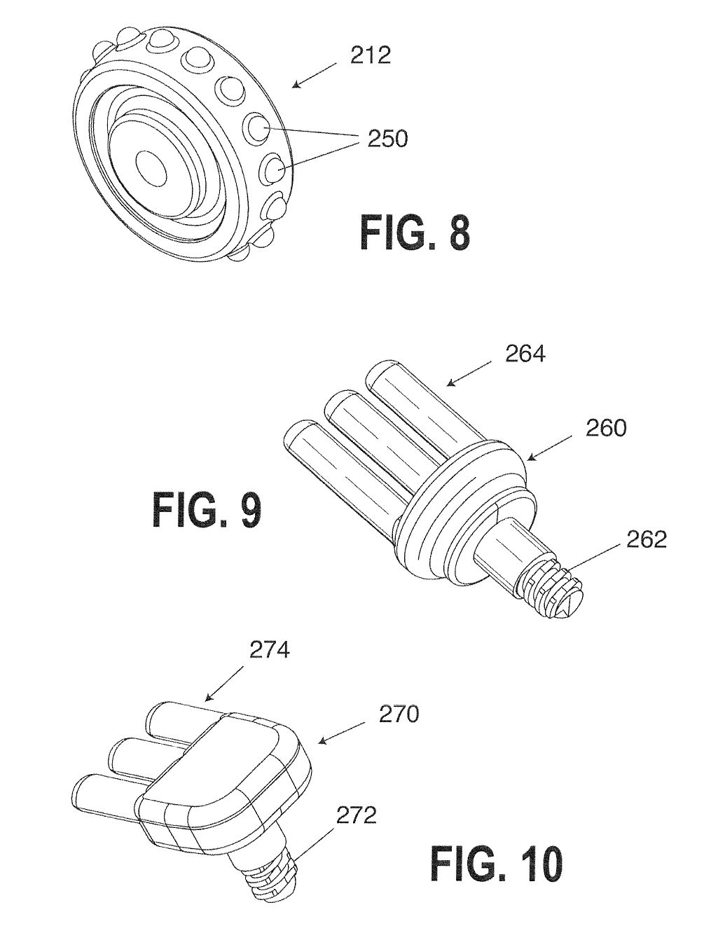

The wheel 212 is shown as being smooth. Other embodiments of the wheel 212 may have protrusions extending therefrom. For example, referring to FIG. 8, the wheel 212 may have a plurality of protrusions 250 extending therefrom. The protrusions 250 may, as example, be bumps or ridges that further massage muscles.

The frame 210 has two members 224 that extend to support the wheel 212. The members 224 have a hole 226 that receives a pin or axle 228. The wheel 212 rotates about the axle 228 in a conventional manner. In some embodiments, the axle 228 is removable so that the frame 210 can accommodate other embodiments of the wheel 212. An embodiment of the axle 228 is shown in FIG. 7. The axle 228 has a tabbed end 240 that secures the axle 228 in the frame 210, FIG. 6. When the tabbed end 240 is squeezed, the axle 228 can be removed from the frame 210, which releases the wheel 212. The shape of the tabbed end 240 enables the axle 228 to be readily inserted into the frame 210, which further enables quick replacement of the wheel 212 with another device.

Other types of massage elements may be attached to the massager 100. For example, referring to FIG. 9, a massage element may be a scratcher 260. The scratcher 260 has a connector that enables it to be secured to the massager 100. In the embodiment of FIG. 9, the connector is a threaded portion 262 that may be threaded into the massager as described above with reference to other massage elements. The scratcher 260 has a plurality of fingers 264 extending therefrom. The fingers 264 extend in a direction that is substantially parallel to the direction that the threaded portion 262 extends.

A second embodiment of a scratcher 270 is shown in FIG. 10. The scratcher 270 includes a threaded portion 272, but could have another type of coupler. The scratcher 270 has a plurality of fingers 274 that extend substantially perpendicular to the direction in which the threaded portion 272 extends. It is noted that both scratchers 260, 270 have three fingers 264, 274 extending therefrom, however, any number of fingers may extend therefrom.

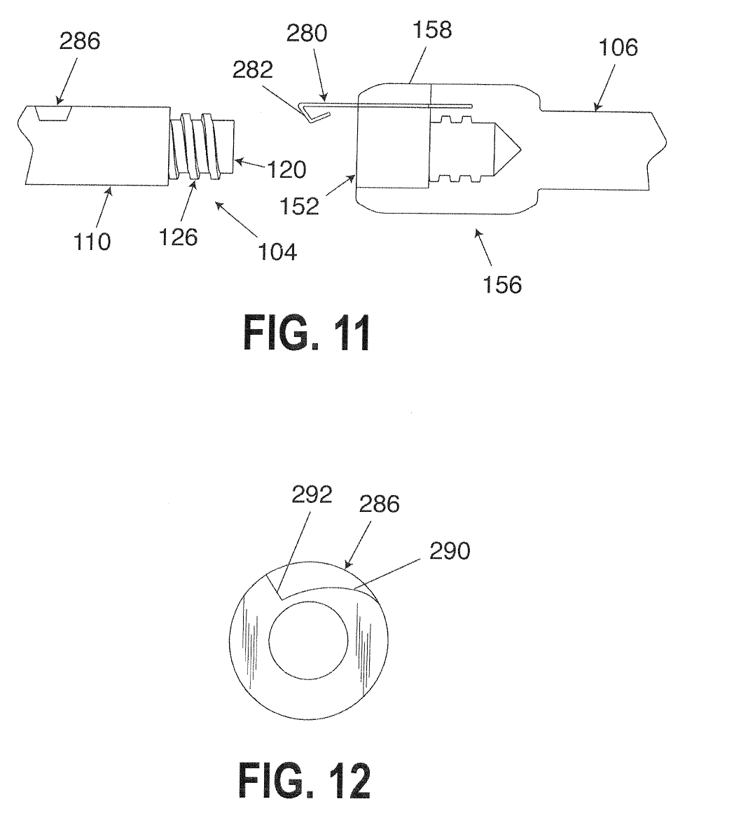

Another embodiment of a coupling section 156 is shown in FIG. 11. The coupling section 156 includes a locking tab 280 that extends from the second end 152 of the straight portion 106. The locking tab 280 has a protrusion 282 formed thereon. The locking tab 280 is flexible so as to enable the protrusion 282 to move relative to the second end 152 of the straight portion 106 and to return to its original position.

The curved portion 104 has a recess 286 proximate the first end 120 that is sized to receive at least a portion of the protrusion 282. When the protrusion 282 or at least a section of the protrusion is located in the recess 286, the curved portion 104 and the straight portion 106 are locked. More specifically, the locking tab 280 prevents the two portions 104, 106 from unscrewing from each other. The curved portion 104 may be unscrewed from the straight portion 106 by lifting the locking tab 180 to remove the protrusion 282 from the recess 286.

Another embodiment of the recess 286 is shown in FIG. 12, which is a cut away view of the curved portion 104. In this embodiment, the recess 286 includes ramp 290 and a wall 292. As the curved portion 104 and the straight portion 106 are screwed together, the protrusion 282 falls over the wall 292 and slides up the ramp 290 where it contacts the outer surface of the curved portion 104. Therefore, the locking tab 280 does not have to be lifted out of the recess 286 as the portions 104, 106 are screwed together.

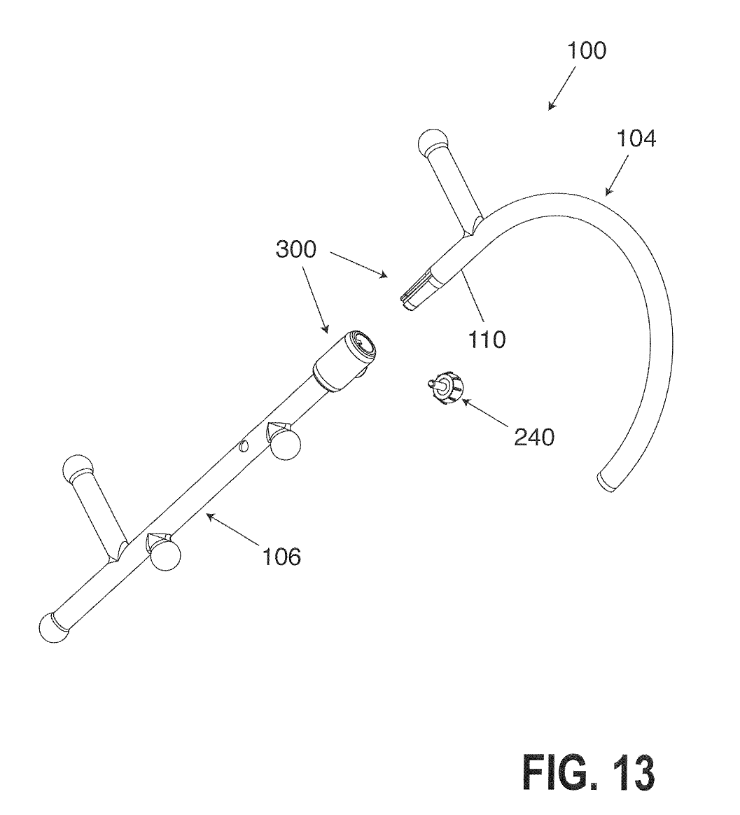

If the portions 104, 106 start to become unscrewed from one another, the protrusion 282 contacts the wall 292 and prevents the unscrewing. The portions 104, 106 may be unscrewed from each other by lifting the protrusion 282 during the unscrewing. This effectively locks the portions 104, 106 together after they have been screwed together. Other embodiments for securing the curved portion 104 to the straight portion 106 are described below. Referring to FIG. 13, which is a perspective view of an embodiment of the massager, coupling a mechanism 300 may include a slot and an extended protrusion for securing the curved portion 104 to the straight portion 106. The coupling mechanism 300 includes the coupling sections from both the curved portion 104 and the straight portion 106. As described below, this embodiment of the massager 100 has a slot in one portion that is configured to receive an extended protrusion located on the other portion. In the embodiment of FIG. 13, the slot is located in the curved portion and the protrusion is located in the straight portion 106.

An enlarged view of the second end 152 of the massager 100 is shown in FIG. 14. The second end 152 has a coupling section 200 that uses an extended protrusion 204 that is received in a slot located on the curved portion 104 (described below). The coupling section 200 includes an opening or cavity 202 that has the protrusion 204 extending into the cavity 202. In some embodiments, the cavity 202 is tapered. In the embodiment of FIG. 14, the protrusion 204 is elongated and extends in the direction of the straight portion 106, however, the protrusion 204 does not have to be elongated. In some embodiments, the protrusion may consist of a plurality of protrusions that may or may not be elongated. For example, the cavity 202 may have a plurality of protrusions extending therein.

The coupling section 200 also has a hole 210 extending into the cavity. A base 212 surrounds the hole 210. The base may be substantially flat and serves to support a securing mechanism as described in greater detail below. The hole 210 may be threaded. For example, threads may be molded into the coupling section 200 or a threaded insert may be affixed into the hole 210. The treads are used when the securing mechanism is a screw and they serve to maintain the screw in the hole 210 as described in greater detail below.

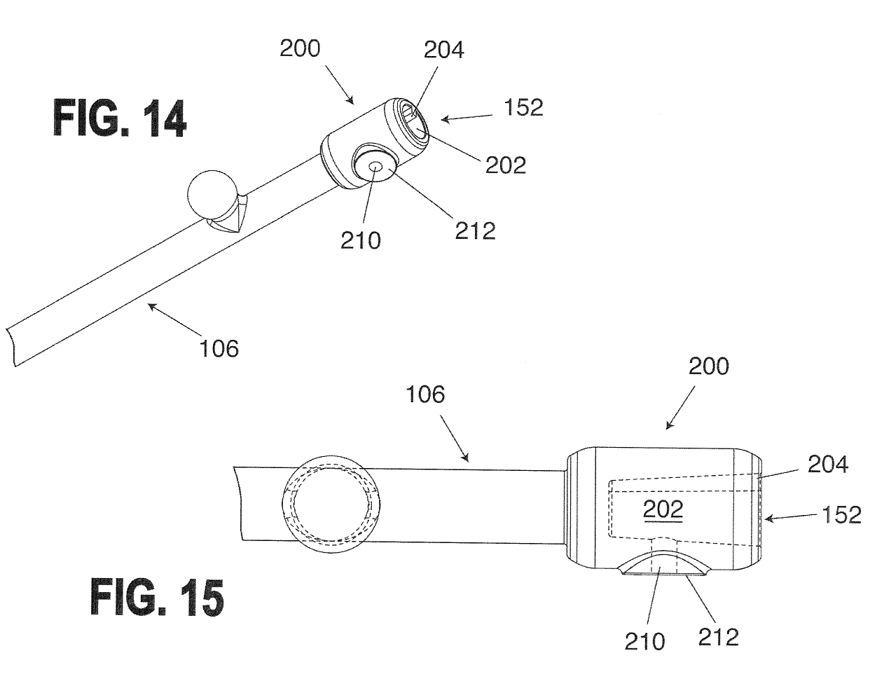

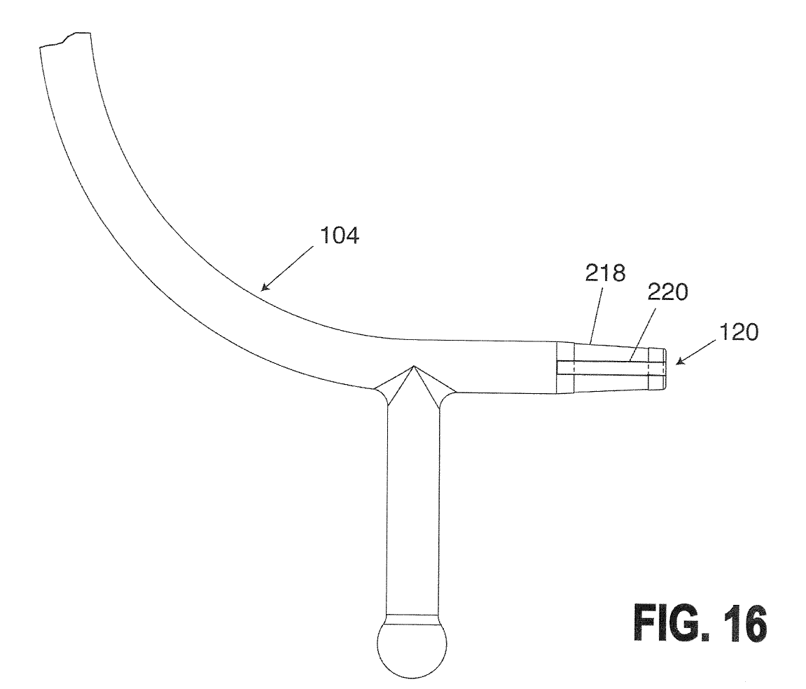

FIG. 15 is a cut away view of the second end 152 of the straight portion 106. FIG. 15 shows the embodiment wherein the cavity 202 is tapered. The taper provides for a better fit of the curved portion 104 into the cavity 202. As shown, the hole 210 passes through to the cavity 202 to enable a securing mechanism to contact the curved portion 104.

FIG. 16 shows an enlarged view of the first end 120 of the curved portion 104. The first end 120 is configured to be received by the coupling section 200 of the straight portion 106 of FIG. 14. As shown, the first end 120 has a tapered section 218 that matches the taper of the cavity 202 of the coupling section 200. The first end 120 has a slot 220 located thereon. The slot 220 is configured to receive the protrusion 104 in the coupling section 200. Therefore, the slot 220 is configured per the protrusion 204.

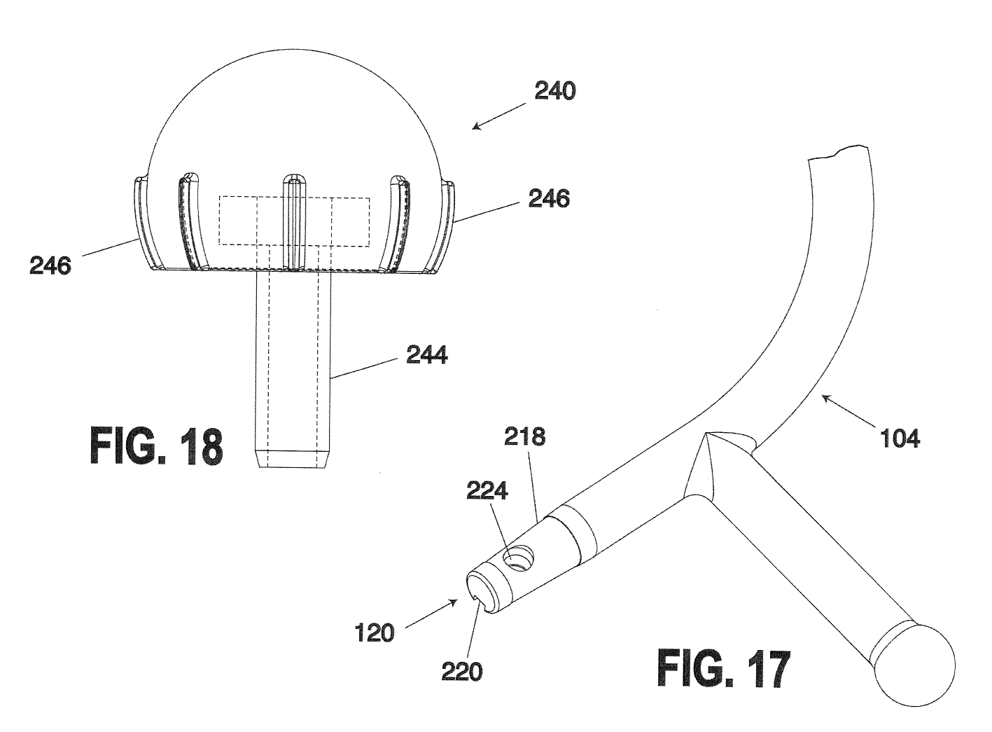

An opposite view of the tapered section 218 is shown in FIG. 17. The tapered section 218 includes a hole 224 that is configured to receive the securing device that passes through the hole 210 in the coupling device 200. In the embodiment of FIG. 17, the hole 224 is located opposite the slot 220.

An embodiment of a securing mechanism 240 is shown in FIG. 18. The securing mechanism 240 include a head 242 and a shaft 244. The head 242 may be substantially similar to one of the massage elements located on the massager 100, FIG. 1. The head 242 may include a plurality of protrusions 246 that enable a user to grasp the head 242 when he secures it to the massager 100. The shaft 244 may be threaded so as so to screw into the hole 210, FIG. 14, or the hole 224, FIG. 17.

Having described the components of the massager 100, its operation will now be described. The massager 100 is in two pieces, which enables it to be easily stored and shipped. When the massager 100 is to be used, the first end 120 of the curved portion 104 is inserted into the coupling section 200 of the straight portion 106. During insertion, the protrusion 204 is received into the slot 220. The tapered portion 218 of the fist end 220 enables for a tight fit into the cavity 202. When the two portions 104, 106 are attached to each other, the securing mechanism 240 is secured to the massager 100. In the embodiment of FIG. 17, the securing mechanism 240 is screwed into the hole 210 in the coupling section 200 where it passes into the hole 224 in the curved portion 104. When the securing device 240 is tightened, the curved portion 104 is secured to the straight portion 106.

Having described several embodiments of the massager 100, embodiments of using the massager 100 will now be described. One embodiment for using the massager 100 is referred to as ischemic compression. Ischemic compression is used in both Shiatsu and trigger point work. The purpose of ischemic compression is to deliberately increase the blockage of blood to an area so that, upon release, there will be a resurgence of blood. This washes away waste products, supplies necessary oxygen and helps the affected tissue to heal. This increase of blood flow to the area is called a hyperemia. The above-described massage elements are used to compress muscles and the like to create ischemic compression.

Application of ischemic compression involves relaxing a muscle and stretching it to the verge of discomfort. A massage element, such as a ball is pressed directly on the muscle to create tolerably painful (7 to 8 on a pain scale of 10), sustained pressure. As the discomfort tends to abate, pressure is gradually increased by adding more pressure. This process is continued up to one minute. If muscle tenderness continues, the procedure can be repeated.

What is claimed is:

1. A massager comprising:
a first portion and a second portion, said first portion comprising:
a first end and a second end wherein at least a section of said first portion between said first end and said second end is curved;
a coupling section located proximate said first end, said coupling section being configured to attach to a coupling section on said second portion of said massager to join said first and second portions; and
a coupling section located on said second end, said coupling section being configured to receive a massage element; and
said second portion comprising:
a substantially straight member extending between a first end and a second end, wherein said the coupling section is located on said second end.

2. The massager of claim 1, wherein said massage element comprises a roller.

3. The massager of claim 2, wherein said roller comprises a plurality of protrusions extending therefrom.

4. The massager of claim 2, wherein said roller comprises a wheel rotatably and removably attached to a frame.

5. The massager of claim 1, wherein the coupling section on said first end of said first portion and the coupling section on the second end of said second portion comprise threaded portions and tapped portions so that said first portion and said second portion can be screwed together via said coupling sections.

6. The massager of claim 1, wherein the coupling section on said second end of said first portion and said massage element include threads so that said massage element may be screwed into said second end of said first portion.

7. The massager of claim 1, wherein said second portion further comprises a handle.

8. The massager of claim 1, wherein said member further comprises at least one massage element connected thereto.

9. The massager of claim 1 wherein said second portion first end has a massage element that is connectable thereto.

10. The massager of claim 9, wherein said massage element comprises a ball.

11. A massager comprising:
a first portion, said first portion comprising:
a first end and a second end;
a second portion, said second portion comprising:
a first end and a second end oppositely disposed relative to said first end, said second end comprising a cavity, wherein said first end of said first portion is receivable in said cavity.

12. The massager of claim 11, wherein said first end of said first portion is tapered and wherein said cavity is configured to receive the tapered first end of said first portion.

13. The massager of claim 11, wherein said cavity comprises at least one protrusion, wherein said first end of said first portion comprises at least one slot, and wherein said at least one protrusion is receivable in said at least one slot.

14. The massager of claim 13, wherein said at least one protrusion is elongated and wherein said at least one slot is elongated to receive the elongated protrusion.

15. The massager of claim 11, wherein said first portion first end has a hole, wherein said second portion second end has a hole, wherein said the holes align when said first portion is attached to said second portion, and wherein a securing device is receivable in said holes.

16. The massager of claim 15, wherein said securing device comprises a threaded screw.

17. The massager of claim 16, wherein said hole in said second portion first end is threaded.

18. The massager of claim 15, wherein said securing mechanism comprises a shaft and wherein said shaft is receivable in the holes.

19. The massager of claim 15, wherein said securing mechanism comprises a head and wherein said head is locatable on the exterior of said second portion second end when said securing mechanism is located in the holes.

20. The massager of claim 15, wherein said head comprises at least one protrusion extending therefrom.
